(19) United States
(12) Patent Application Publication
(10) Pub. No.: US 2022/0322638 A1
(43) Pub. Date: Oct. 13, 2022

(54) DOG-TRAINING SYSTEM

(71) Applicant: Oliver GALVEZ, Grayson, GA (US)

(72) Inventor: Oliver GALVEZ, Grayson, GA (US)

(21) Appl. No.: 17/227,139

(22) Filed: Apr. 9, 2021

(51) Int. Cl. A01K 15/02; H04W 4/021; A01K 11/00

(52) U.S. Cl. CPC A01K 15/023; H04W 4/021; A01K 11/008

(57) ABSTRACT

A dog-training system may include a user tracking device coupled to a user and a dog tracking device coupled to a dog. The user tracking device may include a first wireless transceiver for exchanging location data with the dog tracking device. The dog tracking device may include a second wireless transceiver for exchanging location data with the user tracking device. A method of training a dog may include obtaining first data associated with the user from the user tracking device and second data associated with the dog from the dog tracking device. The method may include identifying a boundary relative to the user based on the first data and determining whether the dog crosses the boundary based on the second data. The method may include providing feedback to the dog or the user responsive to determining the dog crosses the boundary.

### BACKGROUND

Dogs may be trained to behave in particular ways and/or perform particular actions. Dogs may be trained using a number of methods such as classical conditioning, non-associative learning, operant conditioning, etc. Training a dog may be required for walking the dog to teach the dog proper walking and/or socialization behavior.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a dog-training system may include a user tracking device coupled to a user and a dog tracking device coupled to a dog. The user tracking device may include a first wireless transceiver for exchanging location data with the dog tracking device. The dog tracking device may include a second wireless transceiver for exchanging location data with the user tracking device.

In some embodiments, a method may include identifying a boundary relative to the user and determining whether the dog crosses the boundary. The method may include providing feedback to the dog and/or the user in response to the dog crossing the boundary.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1A illustrates an example embodiment of a dog-training system according to the present disclosure;

FIG. 1B illustrates an example embodiment of a dog-training system including two transceiver devices on one side of a user according to the present disclosure;

FIG. 2 is a diagram representing an example embodiment of the dog training system according to the present disclosure;

FIG. 3 is a flowchart of an example method of operations of the dog training system according to the present disclosure; and

FIG. 4 is an example computing system.

### DETAILED DESCRIPTION

Dogs traveling in a pack may recognize a dog at the front of the pack as the leader of the pack. This instinct of recognizing the dog at the front of the pack as the leader may carry over to the act of walking a dog. When walking a dog, the dog is often positioned in front of a human, and movement of the dog is controlled by a leash held by the human. Such positioning of the dog and the human may inadvertently teach the dog that the dog is the leader during a walk.

Correcting the positioning of the dog during a walk may be difficult. It may be difficult for a human who is walking the dog to keep track of the positioning of the dog when the dog is not walking in front of the human. The human may become fatigued due to constant manual intervention needed to train and/or correct behavior of the dog. Such fatigue may discourage the human from bringing the dog out for walks, which may result in a feedback loop of diminished training discipline and/or socialization for the dog.

The present disclosure relates to, among other things, a dog training system. The dog training system may include a first tracking device coupled to a human-user and a second tracking device coupled to a dog. The first tracking device may be attached to an article of clothing (e.g., a belt, pocket, shirt, etc.) worn by the human-user and/or to a device carried by the human-user (e.g., a watch, smartphone, other handheld device, etc.). The second tracking device may be attached to the dog via a dog-attachment member, such as a collar, a harness, a tracking chip, etc. The first tracking device may be configured to detect a location, distance, movement, or other parameter of the second tracking device, and/or the second tracking device may be configured to detect a location, distance, movement, or other parameter of the first tracking device. The first tracking device and/or the second tracking device may provide feedback based on the detected location, distance, movement, or other parameter. The dog training system according to the present disclosure may, among other things, provide a method of training a dog to walk adjacent to and/or behind a human. The dog training system may provide near instant feedback which may assist the dog in associating various walking behavior with their corresponding outcomes. The feedback provided by the dog training system may facilitate training the dog to behave in certain ways with minimal input by the human.

Embodiments of the present disclosure are explained with reference to the accompanying figures.

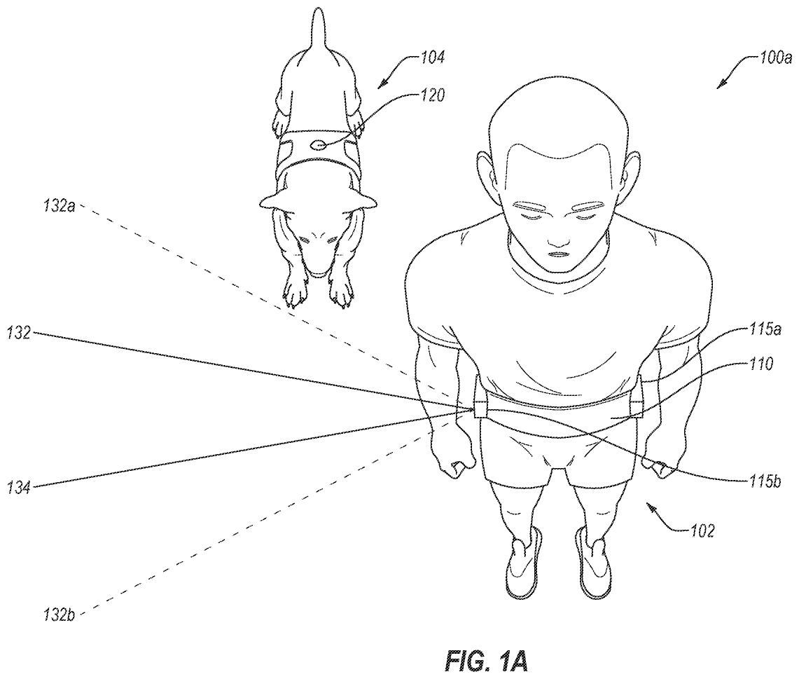

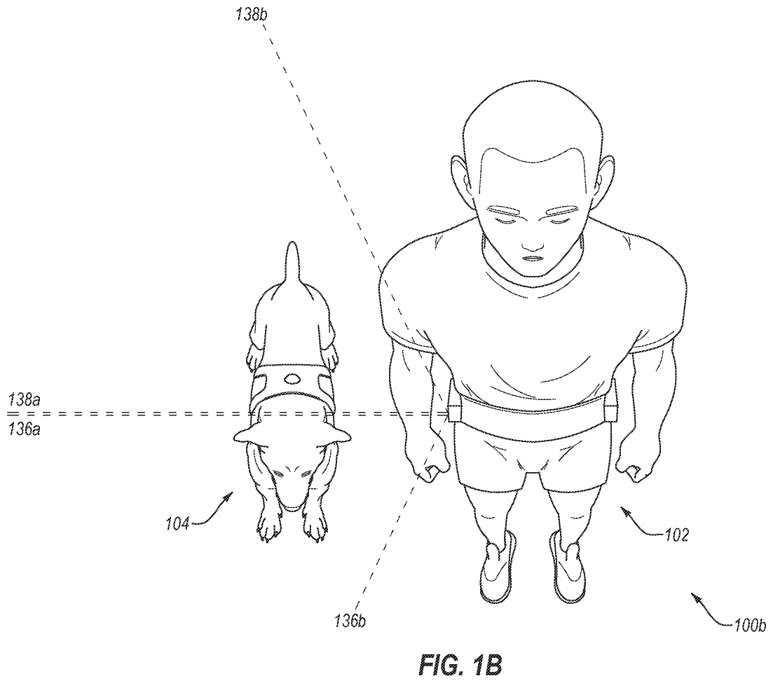

FIG. 1A illustrates an example embodiment of a dog-training system 100a according to the present disclosure. The dog-training system 100a may include a user tracking device 110 and a dog tracking device 120. The user tracking device 110 and the dog tracking device 120 may communicate with each other via a wireless protocol such as ultra-wideband (UWB), Direction Finding Bluetooth, or some other protocol to facilitate determining a direction from which a wireless signal originates and calculating an Angle of Arrival (AoA) and/or an Angle of Departure (AoD) of the wireless signal. The dog-training system may use the AoA and/or the AoD to determine the location of the dog tracking device 120 relative to the user tracking device 110. Actions may be triggered when the dog tracking device 120 enters and/or leaves an area of detection of the user tracking device 110.

In some embodiments, the user tracking device 110 and/or the dog tracking device 120 may be configured to perform one or more functions based on the collected data. For example, the user tracking device 110 and/or the dog tracking device 120 may provide audio, visual, and/or haptic feedback to the user 102 and/or the dog 104 through their respective tracking devices and/or other devices in response to the collected data satisfying one or more particular conditions and/or thresholds. Additionally or alternatively, operation of the user tracking device 110 and/or the dog tracking device 120 may be reduced to conserve energy in response to identifying collected data indicating the user 102 and/or the dog 104 are not actively in motion.

In these and other embodiments, the dog 104 may be trained to walk behind the user 102 using the dog-training system 100a. For example, the dog-training system 100 may be configured to train the dog 104 to walk behind and/or next to the user 102. As such, the dog tracking device 120 may be configured to provide a first feedback to the dog 104 in response to the dog 104 approaching and/or passing a first boundary 132 regardless of the distance between the dog 104 and the user 102. The first boundary 132 may represent a partition line indicating the dog 104 is walking in front of the user 102 or close to walking in front of the user 102. In some embodiments, the first boundary 132 may be a relative boundary determined based on the locations and/or the orientations of the user 102 as detected by the transceiver devices 115a and 115b. The first boundary 132 may be an orthogonal line relative to the direction in which the user 102 faces and/or walks at a given point in time. Additionally or alternatively, the location, direction, range, etc. of the first boundary 132 may be adjusted, such as by the user 102 based on how the user 102 wants to train the dog 104. For example, the user 102 may specify that the first boundary 132 should be angled as shown by the boundary line 132a to train the dog 104 to walk further behind the user 102. As another example, the user 102 may specify that the first boundary 132 should be angled as shown by the boundary line 132b to train the dog 104 to walk adjacent to the user 102.

In these and other embodiments, the user 102 may specify angling of the first boundary 132 based on user preference regarding how the user 102 wants to train the dog 104. The dog-training system 100a may include a controller with which the user 102 may adjust the first boundary 132. For example, the dog-training system 100a may include an app on the user's smartphone through which the user 102 may specify an angle of the first boundary 132. Additionally or alternatively, the user tracking device 110 may include controls (e.g., a dial, one or more buttons, etc.) for adjusting the angle of the first boundary 132.

In some embodiments, the transceiver devices may include a field of detection that does not sufficiently cover a desired area around the user 102 and/or a dog 104. In these and other embodiments, transceiver devices may have a limited field of detection such that the location of the user 102 and/or the dog 104 outside of the field of detection are not perceived by the system. For example, a particular transceiver using UWB signals may accurately detect the location of the user 102 and/or the dog 104 within a field of detection of approximately seventy degrees. In the above example, a dog 104 walking behind or to the side of the user 102 may not be detected by the particular transceiver or detection of the dog 104 may not be accurate enough to warrant activation of feedback. Because the dog 104 may walk on either side of the user 102, the user tracking device 110 may include two or more transceiver devices in order to provide a wider field of detection around the user 102 and/or the dog 104. In these and other embodiments, a first transceiver device 115a may be positioned opposite from a second transceiver device 115b such that the dog 104 may be detected by the first transceiver device 115a and/or the second transceiver device 115b.

Additionally or alternatively, two or more transceiver devices may be oriented in similar directions to provide a wider field of detection in a given direction. For example, FIG. 1B illustrates an example embodiment of a dog-training system 100b including two transceiver devices using UWB signals positioned on one side of a user according to the present disclosure. The dog-training system 100b may include a first transceiver device including a field of detection bound by the first boundary 136a and a second boundary 136b and a second transceiver device including a field of detection bound by a third boundary 138a and a fourth boundary 138b. In these and other embodiments, a transceiver device may include antenna arrays of varying configurations to increase the field of detection and/or improve location detection accuracy.

In some embodiments, including two or more transceiver devices facing a given side of a user may widen the field of detection in the direction of that given side such that more location and/or orientation data about the dog 104 may be obtained relative to only using one transceiver device. The two or more transceiver devices may be communicatively coupled such that data obtained by one of the transceiver devices may be shared with other transceiver devices facing the same direction. For example, the first transceiver device and the second transceiver device may be positioned such that the first boundary 136a and the third boundary 138a are orthogonal to a direction in which the user 102 is walking or facing. In this example, the first transceiver device may detect the location of the dog 104 in situations in which the dog 104 moves in front of the user 102, while the second transceiver device may detect the location of the dog 104 when the dog 104 is behind the user 102. As such, the dog-training system 100b may be configured to provide feedback to the user 102 and/or the dog 104 in response to the dog 104 moving into the field of detection of the first transceiver device.

Returning to FIG. 1A, whether the dog 104 approaches and/or passes the first boundary 132 may be determined based on the location data collected by the user tracking device 110 and the dog tracking device 120. The location data associated with the dog tracking device 120 may be analyzed relative to the location and orientation of the user tracking device 110 to determine whether the dog 104 exceeds the first boundary 132. Additionally or alternatively, the dog tracking device 120 may be configured to provide a second feedback to the dog 104 in response to the dog 104 approaching and/or passing a second boundary 134. In these and other embodiments, the location, direction, range, etc. of the second boundary 134 may be adjusted, such as by the user 102, in the same or a similar manner as adjusting the first boundary 132.

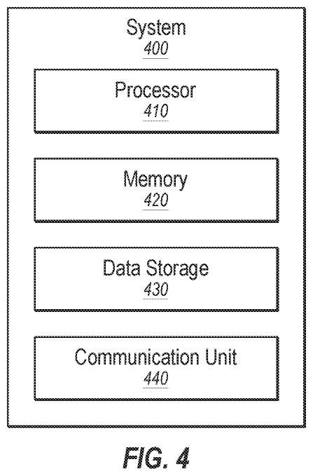

False positive feedback events may inadvertently be triggered when the user turns to look back at something. To address this, and other similar problems, in some embodiments, the user tracking device 110 may contain a switch to toggle engaging feedback and/or the entire system. Additionally or alternatively, the user tracking device 110 may include one or more sensors which may decrease the amount of user input needed to control the dog-training system 100a. The user tracking device 110 may include magnetometers and/or gyroscope sensors. Data collected from such sensors may be compared against an internal clock included in the user tracking device to determine if the user 102 is changing orientation quickly or gradually. In the case of a quick orientation change of the user, such as the user looking back or making a sharp turn, the dog-training system 100 may automatically disable the feedback engine. Once the orientation of the user 102 stabilizes, the feedback engine may be re-enabled automatically. In the case of a gradual orientation change of the user, such as following a curve in a sidewalk, the system may keep the feedback engine engaged throughout the trajectory. In some embodiments, the user tracking device may include other sensors such as a GPS radio, accelerometers, etc. to assist in determining the intent of the user 102 and facilitating less manual intervention by such user. In some embodiments, the sensor data collected by the user tracking device 110 may be transmitted to a computing system, such as the computing system described in relation to FIG. 4, and the calculations and analysis of the sensor data may be performed by the computing system. The computing system may be included as part of the user tracking device 110 or may include a remote computing system separate from the user tracking device 110, such as a cloud computing system.

In some embodiments, the user tracking device 110 may be coupled to the user 102 such that the orientation, positioning, and/or movement of the user tracking device 110 corresponds to the orientation, positioning, and/or movement of the user 102. For example, the user tracking device 110 may be attached to a belt worn by the user 102 such that turning motions made by the user 102 may be identified by the user tracking device 110 as corresponding to changes in orientation of the user 102. Additionally or alternatively, the user tracking device 110 may be attached to an accessory worn by the user 102, such as a bracelet and/or a necklace. Additionally or alternatively, the user tracking device 110 may be included as a software application on a smartphone carried by the user 102. Additionally or alternatively, the user tracking device 110 may be a piece of hardware (e.g., a handheld device) that the user 102 may use while training the dog 104.

In some embodiments, the dog tracking device 120 may be coupled to the dog 104 such that the orientation, positioning, and/or movement of the dog tracking device 120 corresponds to the orientation, positioning, and/or movement of the dog 104. For example, the dog tracking device 120 may be attached to a harness and/or a collar worn by the dog 104. Additionally or alternatively, the dog tracking device 120 may be included as part of a tracking chip attached to the dog 104. In some embodiments, the dog tracking device 120 may be attached to a first end of a leash, such as the end of the leash coupled to the collar of the dog 104. In these and other embodiments, the user tracking device 110 may be attached to a second end of the leash, such as the end of the leash held by the user 102.

In some embodiments, the user tracking device 110 may be paired with one or more dog tracking devices 120. Pairing the user tracking device 110 with the dog tracking devices 120 may include determining a frequency at which signals may be transmitted and/or received by the user tracking device 110 and the dog tracking devices 120. Additionally or alternatively, each user tracking device 110 and/or dog tracking device 120 may include a unique identifier, and transmission and/or reception of signals between tracking devices may include transmission and/or reception of the unique identifier. The user 102 may be prompted to authorize a given unique identifier such that signal transmission and/or reception between a user tracking device 110 and the user 102 and a dog tracking device 120 including the unique identifier is authorized. In these and other embodiments, unique identifiers may be randomly generated and/or derived from properties of the hardware, such as a near-field communication (NFC) identification number and/or a media access control (MAC) address. Pairing the user tracking device 110 with the dog tracking devices 120 may facilitate walking more than one dog 104 by one user 102. Additionally or alternatively, pairing the user tracking device 110 with the dog tracking devices 120 may prevent signal interference between multiple user tracking devices 110 and/or multiple dog tracking devices 120. Additionally or alternatively, pairing the user tracking device 110 with the dog tracking devices 120 may facilitate filtering of unwanted network packets.

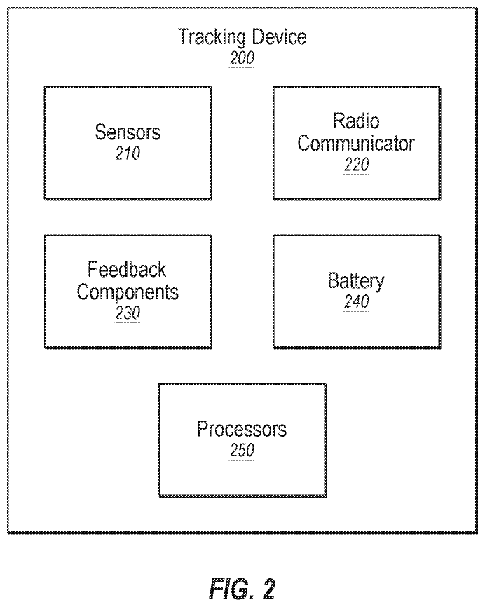

FIG. 2 is a diagram representing an example embodiment of a tracking device 200 used in the dog-training system according to the present disclosure. The tracking device 200 may include one or more sensors 210, one or more radio communicators 220, one or more feedback components 230, one or more batteries 240, and/or one or more computation modules 250 (collectively “the components”). The tracking device 200 may include a plastic and/or metal casing for housing the one or more of the components. The casing of the tracking device 200 may protect the components from physical impacts, particulate matter (e.g., dust, debris, dog hair, etc.), dog saliva, and/or other potential sources of damage to the components.

In some embodiments, the sensors 210 may include an accelerometer, a gyroscope, a GPS locator, and/or other sensors for detecting the orientation, positioning, and/or movement of the user and/or the dog. In these and other embodiments, the sensors 210 may obtain data describing physical parameters relating to a given user and/or a given dog to which the tracking device 200 is attached as described above in relation to FIG. 1A. Additionally or alternatively, the sensors 210 may include an internal clock to facilitate rate calculations, ensure time-synchronized performance of one or more operations, etc.

The radio communicators 220 may include transmitters, receivers, and/or transceivers configured to communicate the data obtained by the sensors 210. In some embodiments, a first tracking device, such as the user tracking device 110, may include a transmitter, and a second tracking device, such as the dog tracking device 120, may include a receiver so that the data associated with the second tracking device may be evaluated relative to the data associated with the first tracking device. Additionally or alternatively, the radio communicators 220 may transmit signals to one or more external feedback components configured to provide feedback to the user and/or the dog.

Additionally or alternatively, each tracking device 200 may include one or more transceivers such that the tracking device 200 may transmit and/or receive data. Including transceivers in lieu of only transmitters or only receivers in the tracking device 200 may provide interchangeability of tracking devices 200 between users and dogs and/or facilitate communication of feedback signals based on data associated with a given user and/or a given dog. In these and other embodiments, the transceivers may facilitate sending and/or receiving information (e.g., location data, orientation data, movement data, etc.) to a data storage such as a cloud server.

In some embodiments, the tracking device 200 may include feedback components 230 that provide audio, visual, and/or haptic feedback to the user and/or the dog. In these and other embodiments, the feedback components 230 may provide feedback responsive to the tracking device 200 obtaining data associated with the user and/or the dog that satisfy one or more conditions. For example, a particular feedback component 230 may include an alarm that produces audio feedback in response to the speed of a particular dog exceeding the speed of a particular user. As another example, a particular feedback component 230 may provide visual feedback that lights up in response to the distance between a particular dog and a particular user exceeding a threshold distance. Additionally or alternatively, the visual feedback may be illuminated with one or more colored lights in response to different conditions. Continuing the example, the visual feedback may generate a yellow light responsive to the distance between the particular dog and the particular user exceeding a first threshold distance and a red light responsive to the distance exceeding a second threshold distance.

As another example, a particular feedback component 230 may include a vibrational alarm that provides haptic feedback to a particular user and/or a particular dog responsive to the particular dog passing a threshold boundary relative to the location of the particular user. Additionally or alternatively, the vibrational alarm may provide a first vibration responsive to the particular dog passing a first threshold boundary and additional vibrations of increasing intensity as the particular dog approaches and/or exceeds a second threshold boundary.

The feedback components 230 may be positioned and/or configured such that the feedback does not cause discomfort or minimal discomfort to the user and/or the dog. In some embodiments, the feedback components 230 may send a confirmation message to the user, such as a feedback signal unique to the confirmation message and send the feedback signal to the dog responsive to receiving approval from the user. In some embodiments, the feedback components 230 may be positioned in the tracking device 200 such that the location at which the feedback is provided does not provide discomfort or minimal discomfort to the user and/or the dog. Additionally or alternatively, the feedback components 230 may be external to the tracking device 200. In these and other embodiments, the tracking device 200 may transmit signals to the external feedback components to provide feedback to the user and/or the dog. Additionally or alternatively, the feedback may include projecting an intermittent signal having a predetermined frequency (e.g., an audio signal projected once every two seconds) and/or a configurable frequency determined by the user.

In some embodiments, the tracking device 200 may include batteries 240 for energy storage. The batteries 240 may provide energy for operations of the sensors 210, the radio communicators 220, the feedback components 230, and/or any other components included in the tracking device 200. In these and other embodiments, the tracking device 200 may include a charging port (not shown) to provide energy for the batteries 240. Additionally or alternatively, the tracking device 200 may include other forms of energy storage and/or generation components, such as supercapacitors and/or solar cells.

The computation modules 250 may include any suitable special-purpose or general-purpose computer, computing entity, or processing device including various computer hardware or software modules and may be configured to execute instructions stored on any applicable computer-readable storage media. For example, the computation modules 250 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. In some embodiments, the tracking device 200 may include computation modules 250 configured to identify one or more boundaries and/or determine whether a dog has passed the boundaries as described above in relation to FIG. 1A.

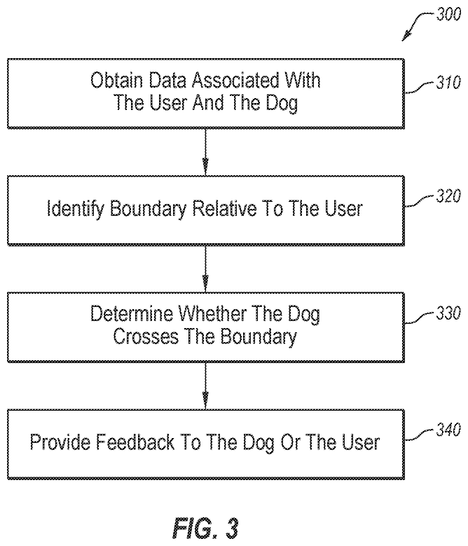

FIG. 3 is a flowchart of an example method 300 of operations of a dog-training system according to the present disclosure. The method 300 may be performed by any suitable system, apparatus, or device. For example, the user tracking device 110, the dog tracking device 120, and/or the tracking device 200 may perform one or more of the operations associated with the method 300. Additionally or alternatively, the method 300 may be performed by an external computing system, such as a cloud computing system. Although illustrated with discrete blocks, the steps and operations associated with one or more of the blocks of the method 300 may be divided into additional blocks, combined into fewer blocks, or eliminated, depending on the particular implementation.

At block 310, data associated with a user and/or a dog may be obtained. The data may describe physical parameters associated with the user and/or the dog such as the location, orientation, and/or movement of the user and/or the dog at a given point in time and/or over a given time period as described above in relation to FIG. 1A.

At block 320, a boundary relative to the user may be identified. In some embodiments, the boundary may be identified based on the location of the user and/or the orientation of the user. In these and other embodiments, the boundary may be orthogonal to or substantially orthogonal to a direction in which the user is oriented as described above in relation to FIG. 1A. At block 330, whether the dog crosses the boundary may be determined based on the location of the dog.

At block 340, feedback may be sent to the user and/or the dog responsive to determining the dog crosses the boundary. The feedback may include audio feedback, visual feedback, and/or haptic feedback. In some embodiments, the feedback may be provided to the user for approval, and the feedback may be provided to the dog responsive to obtaining approval from the user. Additionally or alternatively, the feedback may only be provided to the dog.

Modifications, additions, or omissions may be made to the method 300 without departing from the scope of the disclosure. For example, the designations of different elements in the manner described is meant to help explain concepts described herein and is not limiting. Further, the method 300 may include any number of other elements or may be implemented within other systems or contexts than those described.

FIG. 4 illustrates an example computing system 400, according to at least one embodiment described in the present disclosure. The computing system 400 may include a processor 410, a memory 420, a data storage 430, and/or a communication unit 440, which all may be communicatively coupled. Any or all of the system 400 of FIG. 4 may be implemented as a computing system consistent with the user tracking device 110, the dog tracking device 120, and/or the tracking device 200.

Generally, the processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 410 may include any number of processors distributed across any number of network or physical locations that are configured to perform individually or collectively any number of operations described in the present disclosure. In some embodiments, the processor 410 may interpret and/or execute program instructions and/or process data stored in the memory 420, the data storage 430, or the memory 420 and the data storage 430. In some embodiments, the processor 410 may fetch program instructions from the data storage 430 and load the program instructions into the memory 420.

After the program instructions are loaded into the memory 420, the processor 410 may execute the program instructions, such as instructions to perform the method 300 of FIG. 3. For example, the processor 410 may obtain instructions regarding obtaining data associated with a user, transmitting the data to a dog tracking device (e.g., the dog tracking device 120), obtaining data associated with a dog, determining one or more feedback signals to be sent to the user and/or the dog, and/or transmitting the feedback signals to the user and/or the dog.

The memory 420 and the data storage 430 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 410. For example, the memory 420 and/or the data storage 430 may store obtained data (such as the data associated with the user tracking device 110 and/or the dog tracking device 120). In some embodiments, the computing system 400 may or may not include either of the memory 420 and the data storage 430.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

The communication unit 440 may include any component, device, system, or combination thereof that is configured to transmit or receive information over a network. In some embodiments, the communication unit 440 may communicate with other devices at other locations, the same location, or even other components within the same system. For example, the communication unit 440 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 440 may permit data to be exchanged with a network and/or any other devices or systems described in the present disclosure. For example, the communication unit 440 may allow the system 400 to communicate with other systems, such as computing devices and/or other networks.

One skilled in the art, after reviewing this disclosure, may recognize that modifications, additions, or omissions may be made to the system 400 without departing from the scope of the present disclosure. For example, the system 400 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A dog-training system comprising:
a user tracking device comprising a first transceiver configured to determine a location of a user and an orientation of the user;
a dog tracking device comprising a second transceiver configured to determine a location of a dog; and
a computing system configured to receive the location of the user, the orientation of the user, and the location of the dog, the computing system comprising:
one or more processors; and
one or more non-transitory computer-readable storage media configured to store instructions that, in response to being executed, cause the system to perform operations, the operations comprising:
identifying a boundary based on the location of the user and the orientation of the user;
determining whether the dog crosses the boundary based on the location of the dog; and
providing feedback to the dog or the user responsive to determining the dog crosses the boundary.

2. The dog-training system of claim 1, wherein the first transceiver and the second transceiver each include at least one of an ultra-wideband (UWB) radio, a GPS locator, or a Bluetooth device.

3. The dog-training system of claim 1, wherein:
the computing system is remote from the user or the dog;
the user tracking device is configured to transmit the location of the user and the orientation of the user to the computing system; and
the dog tracking device is configured to transmit the location of the dog to the computing system.

4. The dog-training system of claim 1, wherein the first transceiver and the second transceiver include at least one of: a GPS locator, an accelerometer, a gyroscope, or a magnetometer.

5. The dog-training system of claim 1, wherein the user tracking device further comprises a feedback component configured to provide visual feedback, audio feedback or haptic feedback to the user coupled to the user tracking device in response to determining that the dog crosses the boundary.

6. The dog-training system of claim 1, wherein the dog tracking device further comprises a feedback component configured to provide visual feedback, audio feedback or haptic feedback to the dog coupled to the dog tracking device in response to determining that the dog crosses the boundary.

7. The dog-training system of claim 6, wherein the boundary identified based on the location of the user and the orientation of the user is orthogonal to or substantially orthogonal to a direction in which the user is oriented.

8. The dog-training system of claim 6, wherein the feedback component comprises an external feedback component configured to provide the visual feedback, the audio feedback, or the haptic feedback to the dog in response to determining that the dog crosses the boundary.

9. The dog-training system of claim 1, wherein the user tracking device is configured to be coupled to the user via a user-attachment member, the user-attachment member comprising at least one of an article of clothing, an accessory, a leash in contact with the user.

10. The dog-training system of claim 1, wherein the dog tracking device is configured to be coupled to the dog via a dog-attachment member, the dog-attachment member comprising at least one of a harness, a collar, a leash, or a tracking chip in contact with the dog.

11. The dog-training system of claim 1, wherein the user tracking device is an application on a smartphone including a Bluetooth radio or a UWB radio.

12. A method comprising:
obtaining first data associated with a user from a user tracking device;
obtaining second data associated with a dog from a dog tracking device;
identifying a boundary relative to the user based on the first data;
determining whether the dog crosses the boundary based on the second data; and
providing feedback to the dog or the user responsive to determining the dog crosses the boundary.

13. The method of claim 12, wherein:
the first data includes at least one of: orientation data, location data, or movement data associated with the user; and
the second data includes at least one of: orientation data, location data, or movement data associated with the dog.

14. The method of claim 12, wherein the feedback is only provided to the dog.

15. The method of claim 12, wherein providing the feedback to the dog or the user comprises:
providing the feedback to the user for approval; and
providing the feedback to the dog responsive to obtaining approval from the user.

16. The method of claim 12, wherein the feedback includes at least one of: audio feedback, visual feedback, or haptic feedback.

17. One or more non-transitory computer-readable storage media configured to store instructions that, in response to being executed, cause a system to perform operations, the operations comprising:
obtaining first data associated with a user from a user tracking device;
obtaining second data associated with a dog from a dog tracking device;
identifying a boundary relative to the user based on the first data;
determining whether the dog crosses the boundary based on the second data; and
providing feedback to the dog or the user responsive to determining the dog crosses the boundary.

18. The one or more non-transitory computer-readable storage media of claim 17, wherein the first data and the second data include at least one of: orientation data, location data, or movement data associated with the user or the dog.

19. The one or more non-transitory computer-readable storage media of claim 17, wherein providing the feedback to the dog or the user comprises:
providing the feedback to the user for approval; and
providing the feedback to the dog responsive to obtaining approval from the user.

20. The one or more non-transitory computer-readable storage media of claim 17, wherein the feedback includes at least one of: audio feedback, visual feedback, or haptic feedback.
